(19) United States
(12) Patent Application Publication
(10) Pub. No.: US 2011/0293380 A1
(43) Pub. Date: Dec. 1, 2011

(54) PNEUMATIC COMPRESSED-AIR TUBE TRANSPORT SYSTEM

(75) Inventors: Michael Kai Stuke, Bielefeld (DE); Klaus Biervert, Spenge (DE); Frank Schenda, Kirchlengern (DE)

(73) Assignee: HETTICH HOLDING GMBH & CO. OHG, Kirchlengern (DE)

(21) Appl. No.: 13/147,108

(22) PCT Filed: Jan. 26, 2010
(86) PCT No.: PCT/EP2010/050844

§ 371 Date: Aug. 16, 2011

(30) Foreign Application Priority Data
Jan. 31, 2009 (DE) 10 2009 007 012.5

(51) Int. Cl. B65G 53/66; B65G 53/46; B65G 53/36; B65G 53/06

(52) U.S. Cl. 406/22; 406/108; 406/117; 406/122; 406/131; 406/93

(57) ABSTRACT

A pneumatic compressed-air tube transport system and a method for transporting small assembly parts to assembly and processing lines for assembly of products. The transport system includes at least one drop-off branch configured to drop off the small assembly parts into the compressed-air tube transport system. The at least one drop branch includes at least one air flow generator, a butterfly valve located downstream of the air flow generator, and a drop-off station for the small assembly parts located downstream of the butterfly valve. The small assembly parts move through a tube into at least one joining switch and a plurality of delivery stations are configured to receive the small assembly parts.

This application is a national stage of International Application PCT/EP2010/050844, filed Jan. 26, 2010, and claims benefit of and priority to German Patent Application No. 10 2009 007 012.5, filed Jan. 31, 2009, the content of which Applications are incorporated by reference herein.

### BACKGROUND AND SUMMARY

The present disclosure, among other things, relates to a pneumatic compressed-air tube transport system for transporting small assembly parts to assembly and processing lines for assembly of products.

A pneumatic compressed-air tube transport system is known from U.S. Pat. No. 5,217,328. The tube transport system described in this document is used to transport small parts such as screws, bolts or the like through a tube system of storage containers to assembly machines. To this end the computer-controlled compressed-air tube transport system comprises the actual storage container for receiving various small parts, an inlet device downstream of the storage container, a tube system with switches and separators downstream of the inlet device as receiving stations at which the small parts are led out from the tube system and passed into local storage containers on the assembly machines. When used on more complex assembly lines, the tube transport system soon reaches its installation-specific and/or control-dependent limits.

The present disclosure relates to a pneumatic compressed-air tube transport system that addresses and remedies the above-noted limits.

The present disclosure relates to a pneumatic compressed-air tube transport system for transporting small assembly parts to assembly and processing lines for assembly of products. The transport system includes at least one drop-off branch configured to drop off the small assembly parts into the compressed-air tube transport system. The at least one drop branch includes at least one air flow generator, a butterfly valve located downstream of the air flow generator, and a drop-off station for the small assembly parts located downstream of the butterfly valve. The small assembly parts move through a tube into at least one joining switch. A plurality of delivery stations is configured to receive the small assembly parts. The pneumatic compressed-air tube transport system for transporting the small assembly parts may include three drop-off branches. Each drop-off branch may include an air flow generator and a drop-off station for the small assembly parts. The small delivery parts move through a tube into at least one joining switch. A plurality of delivery stations are configured to receive the small assembly parts. The present disclosure also includes a method for controlling the pneumatic compressed-air tube transport system according to the above disclosure. The method includes the step of connecting at all times only one of at least one bunker of the at least one drop-off branch to a separator or an end separator, so that at all times only one type of the small assembly parts is located in a tube area of the compressed-air tube transport system which can be acted upon with compressed air.

In such a manner, the small assembly parts supply of individual assembly stations can be organized with the aid of a pneumatic compressed-air tube transport system even on very complex assembly lines. The installation-specific limits given herein are, in particular, readily overcome by the plurality of drop-off branches having their own air conveyors. An essential advantage of the present disclosure is the possibility of successively conveying parts differing in respect of geometry and/or material, for example, metal and plastic, via the same distribution system, wherein the conveyance of a specific type of part take place continuously in arbitrary quantities and is not restricted to a specific batch volume.

The control device, according to the present disclosure, is provided with a control program for controlling the compressed-air tube transport system.

With this program, the tube transport system can be controlled in such a manner that at all times only one of the bunkers of all the drop-off branches can be connected at all times to only one of the final separators so that at any time only one type of small assembly parts is located in the tube or tubing area of the tube transport system which can be acted upon with compressed air.

The time of action of the air flow of the compressed-air tube transport system for transporting one specific small part is determined in such a manner that no small assembly parts are located in the tubing area of the compressed-air tube transport system acted upon with compressed air before another connection is activated between another bunker and another delivery station.

It is advantageous if the time of action of the air flow of the compressed-air tube transport system for transporting one specific small assembly part is longer than the transport time to the separator calculated from a distance measurement and the small assembly part velocity in the air flow. In this way, it is ensured that the entire tubing system is always completely empty before a new small assembly part is let into the tube system.

It is expedient if the intensity of the air flow of the air flow generator is controlled according to the weight, and possibly depending on the shape thereof, of the small assembly parts to be transported.

Embodiments according to the present disclosure are discussed herein.

With regard to the prior art on compressed-air tube transport systems, also see DE 10 2005 049 597, DE 201 20 905 U1 and DE 299 01 213 U1.

Other aspects of the present disclosure will become apparent from the following descriptions when considered in conjunction with the accompanying drawings.

### BRIEF DESCRIPTION OF THE DRAWINGS

FIG. 1 shows a schematic view of a partial area of a pneumatic compressed-air tube transport system in an x-y plane, according to the present disclosure.

FIG. 2 shows a plan view of a part of the partial area of the compressed-air tube transport system from FIG. 1 in an x-z plane corresponding to the viewing arrow II in FIG. 1 on an enlarged scale.

FIG. 3 shows a schematic view of a complete compressed-air tube transport system in the x-z plane, where different switching states of the individual assemblies are shown by pneumatic symbols, according to the present disclosure.

FIG. 4 shows a bunker for receiving conveyed material in a side view in the z-y plane, according to the present disclosure.

FIG. 5 shows a sectional view of a part of the bunker according to the sectional profile V-V in FIG. 4, wherein an electric motor conveying device having a pneumatically pivotable flap is shown.

FIG. 6 shows a front view of the bunker according to the view in the direction of the arrow VI in FIG. 4.

FIG. 7 shows an enlarged view of the pneumatic drive of a flap shown in the closed end position and by a dashed line, in the open end position, according to the present disclosure.

FIG. 8 shows a front view of a hopper in the x-y plane, where the complete representation of the right part was dispensed with since the hopper is configured symmetrically, according to the present disclosure.

FIG. 9 shows a schematic view of the hopper according to the direction of the arrow IX in FIG. 8.

FIG. 10 shows a partial view of the hopper according to the direction of the arrow X in FIG. 8.

FIG. 11 shows an enlarged view of a conveying tube part with a butterfly valve and a pneumatic drive, according to the present disclosure.

FIG. 12 shows a side view of the butterfly valve according to the view in the direction of the arrow XII in FIG. 11.

FIG. 13 shows an enlarged view in the vertical position of a pneumatic drive in the form of a double-acting pneumatic cylinder including a 4-2-way valve, according to the present disclosure.

FIG. 14 shows an enlarged view with a partially cutaway region of the conveying tube, according to a detail of FIG. 1, as an embodiment of abutting conveying tube parts, where a direction of flow runs from left to right, according to the present disclosure.

FIG. 15 shows a front view of two bunker extensions placed one on top of the other in the x-y plane, according to the present disclosure.

FIG. 16 shows an enlarged view of a roller bearing of a slider, including detail Y from FIG. 15.

FIG. 17 shows a side view of one of the bunker extensions in the x-y plane on a reduced scale, according to the present disclosure.

FIG. 18 shows a plan view on an enlarged scale of a lower region of the bunker extension according to the view of the arrow XVIII in FIG. 15.

FIG. 19 shows a plan view of the bunker in a partial view turned through 90 degrees according to the direction of the arrow XIX in FIG. 16.

FIG. 20 shows a plan view of an inlet device in the x-z plane on enlarged scale, according to the present disclosure.

FIG. 21 shows a view of the inlet system corresponding to the sectional profile XXI-XXI in FIG. 20 with a part of a side plate.

FIG. 22 shows an enlarged sectional view of detail W from FIG. 21.

FIG. 23 shows a sectional view of the inlet system according to the sectional profile XXIII-XXIII in FIG. 20, where the baffle and the conveying air flow constricted thereby are indicated by thin lines.

FIG. 24 shows a view of a part of the inlet system corresponding to the direction of the arrow XXIV in FIG. 20, wherein the fastening of a tube connector with flange clamping device embracing this is shown.

FIG. 25 shows a plan view in the x-z plane of a 4-3-way switch for the selectable making of a connection from one of the three incoming tube connectors to an outgoing tube connector, wherein the connecting tubes are arranged jointly as a connecting tube unit on a carriage and wherein a first switch position is shown, according to the present disclosure.

FIG. 26 shows the connecting tube unit relative to the housing in a second switch position, according to the present disclosure.

FIG. 27 shows the connecting tube unit relative to the housing in a third switch position, according to the present disclosure.

FIG. 28 shows a guide and drive unit carrying the connecting tube unit, according to the present disclosure.

FIG. 29 shows a view of the guide and drive unit in the direction of the arrow XXIX in FIG. 28.

FIG. 30 shows a view into the interior of a separator in the x-y plane with a guide and drive unit shown by the dashed line, according to the present disclosure.

FIG. 31 shows a view of the separator according to the direction of the arrow XXXI in FIG. 30.

FIG. 32 shows a view of a 3-2-way distributor, wherein one switch position of the baffle located in the interior and another switch position through a part of the baffle on a cutaway housing part is shown, according to the present disclosure.

FIG. 33 shows a plan view of the 3-2-way distributor in the direction of the arrow XXXIII in FIG. 32.

FIG. 34 shows a view of a dropping rotary tube switch in the x-y plane, according to the present disclosure.

FIG. 35 shows a view of the dropping rotary tube switch in the direction of the arrow XXXV in FIG. 34.

FIG. 36 shows a schematic view of the dropping rotary tube switch according to FIG. 34.

FIG. 37 shows a schematic view of the dropping rotary tube switch according to the sectional profile XXXVII-XXXVII in FIG. 36.

FIG. 38 shows a view of an end separator in the x-y plane, according to the present disclosure.

FIG. 39 shows a view of the end separator in the direction of the arrow XXXIX in FIG. 38.

### DETAILED DESCRIPTION

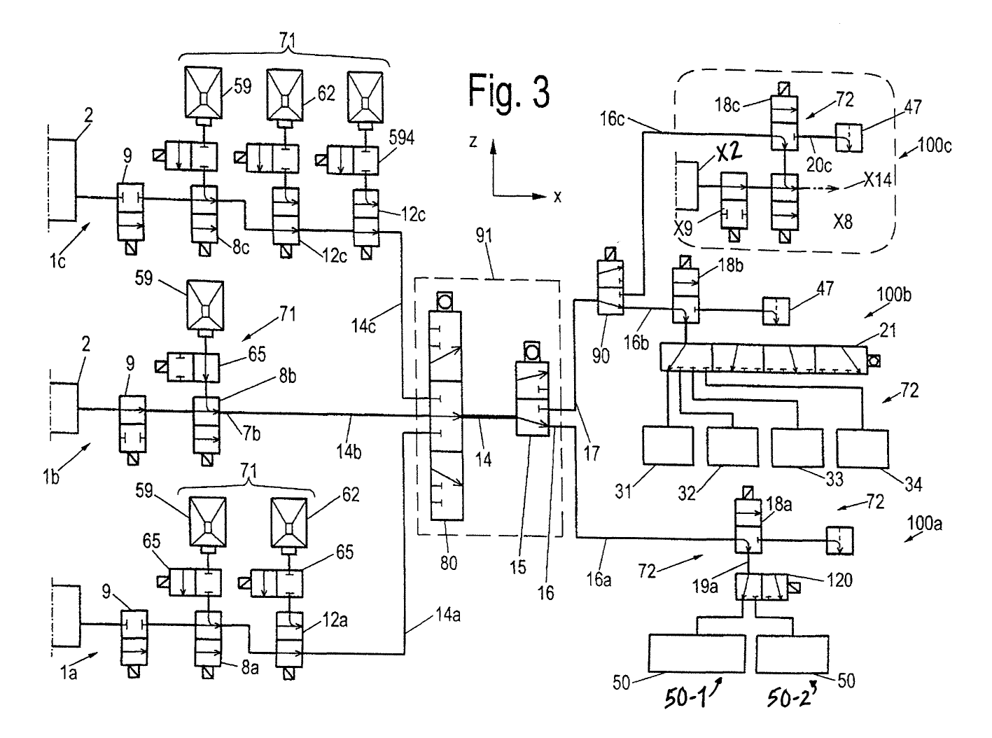

FIG. 3 shows a compressed-air tube transport system in the x-z plane, which has at least one, which could be two or more, and shown as three, drop-off branches 1a, 1b, 1c, each comprising at least one air flow generator 2, a shutoff device downstream of the respective air flow generator 2, for example, a butterfly valve 9, and a drop-off station 71 for small assembly parts downstream of the butterfly valve 9, and which open via tubes 14a, b, 14c into a joining switch 81.

The components arranged in the x direction, relative to the tube 14, apart from the compressed air generator 2 and the butterfly valve 9, form, respectively, one drop-off station 71, and the devices 27 to 30 form a delivery station 72 (see FIG. 1).

As indicated in FIG. 3, a number of components of the compressed-air tube transport system are designed to be controllable, for example, electrically or optically. These components are connected in a wireless manner or by lines 5, as indicated in FIG. 1, for the example, of the air flow generator 2 to a control device 6, indicated in FIG. 1, which serves to control the components.

Firstly, one of the drop-off branches, the drop-off branch 1a, for example, will be described in detail with reference to FIG. 1.

The drop-off branch 1a of the compressed-air tube transport system 1, shown in FIG. 1, has its own air flow generator 2 for generating compressed air for transporting small parts. This is formed, for example, as a centrifugal fan 3 which can be provided with an electric motor 4 for its drive.

The electric motor 4 is connected to the control device 6 via an electrical lead 5.

A, for example, an approximately horizontally/level running, tube 7 is connected to the air flow generator 2, which opens into a first inlet device 8, the tube 7 being provided with the already-mentioned butterfly valve 9 between the centrifugal fan 3 and the inlet device 8.

The butterfly valve 9 allows a rapid switching on and off of the air flow inside the tube system so that this can be switched pressureless or currentless, for example, when switching over tubing switches. Starting up and shutting down the air flow generator 2, on the other hand, is very much more time-consuming.

The inlet device 8 is configured in such a manner that,

in a first position either a connection of the tube 7 to an adjoining tube 10 and a connection to an inlet tube 11 extending at right angles upwards is made, whereby the tube 7 has a cross-sectional narrowing before the mouth of the inlet tube 11, or
in a second position a connection of the tube 7 to the tube 10 is made with full cross-section and the connection to the inlet tube 11 is shut off.

Pneumatic actuators are provided for setting the first or second switching position, which actuators are connected to the control device 6 and can be controlled by device 6.

The tube 10 extends, as shown in FIG. 1, as far as a further inlet device 12, which is configured similarly to the inlet device 8 and can be brought into corresponding switching states. The inlet device 12 is connected to an inlet tube 13 extending vertically upwards and a horizontally running tube 14a.

According to FIG. 3, the first drop-off branch 1a includes two inlet devices, 8a and 12a, downstream of the air flow generator 2. This number of inlet devices 8a, 12a is to be understood to be an example. Thus, it is shown in FIG. 3 that the second drop-off branch 1b, for example, can have only one inlet device 8b and the third inlet branch 1c can have, for example, three inlet devices 8c, 12c, 12c. It is within the scope of the present disclosure that more inlet devices can be arranged successively in a branch, for example, five or even more.

The air flow generator 2 and the inlet devices 8, 12 are, for example, located in a fixed arrangement on a floor a of a factory building, where the tubes 7, 10 and a part of tube 14 can also be fastened on the floor a by fastening parts (not shown).

As a result of the parallel arrangement of a plurality of drop-off branches 1a, 1b, 1c, which open into at least one joining switch 80, the complexity of the compressed-air tube transport system can be affected appreciably by simple means and enables a plurality of different small assembly parts to be conveyed.

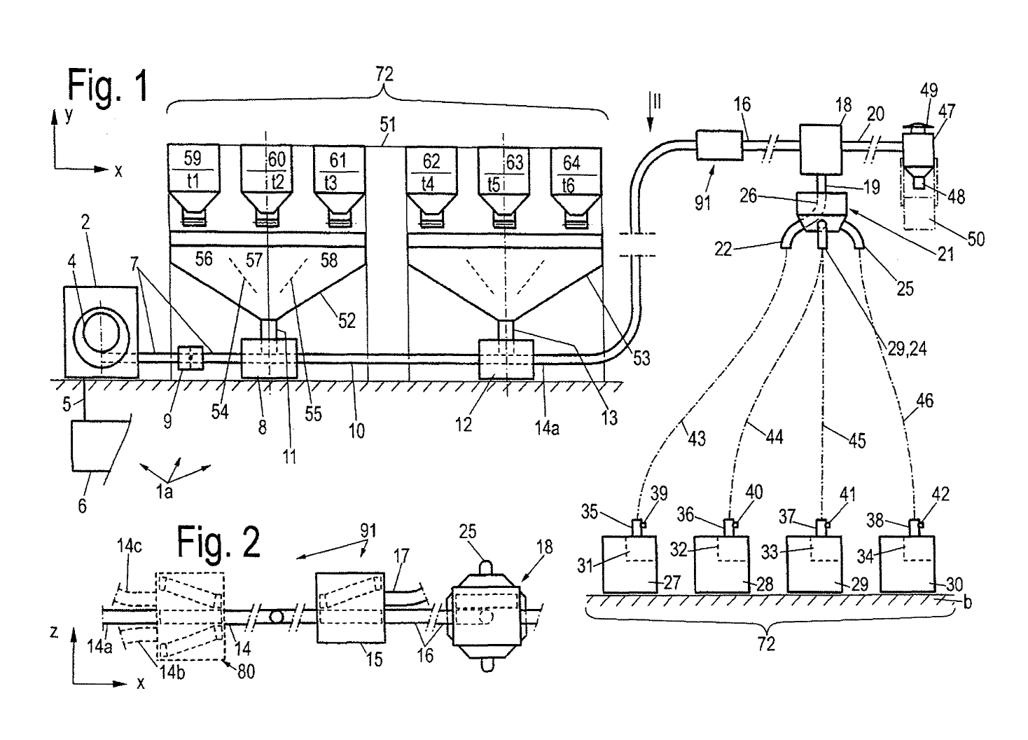

The tube 14a in FIG. 1, for example, has two 90-degree tube bends, not designated in detail, and ends in horizontal course at a switch device 91 which may, for example, include at least one joining switch 80 on an incoming side and at least one branching switch 15 on an outgoing side (see FIG. 2). For the sake of clarity, the tube 14 arranged between the two switches 80 and 15 is shown only as very short in FIGS. 2 and 3, whereas in an actual transport system it bridges the frequently large distance between the small assembly parts stockpile in the warehouse or the small assembly parts requirement point in an assembly hall, for example.

The drop-off branches or tubes are shown as embodiments, according to the present disclosure, in FIG. 3, that is, the three drop-off branches 14a, 14b and 14c, open into the joining switch 80.

Generally, not just one assembly station but a plurality of assembly stations is to be supplied with small assembly parts, at least one branching switch 15, possibly another branching switch 90, may be connected downstream of the tube 14 following the joining switch 80 in order to branch off the small assembly parts initially in different supply lines, for example, delivery branches 100a, 100b, 100c through which the small assembly parts can be conveyed to different delivery stations 72 at different assembly stations.

The branching switch 15, designed, for example, as a 3-2-way system, may, for example, be brought into two switching positions by a pneumatic actuator so that either a continuous connection of the tube 14 to a tube 16, running coaxially thereto, can be made, or a connection of the tube 14 to at least one branching-off tube 17 can be made (see FIG. 2 and FIG. 3).

According to FIG. 2, the switch 15 with the tube 17 forms a branching switch, the tube 17 forming a further conveying line which, like the tube 16, ends at corresponding components such as the separator 18 with the drop tube 19, the distributor 21 with the connected devices 27 to 30 and the end separator 47. See also FIG. 1.

According to FIG. 2, the compressed-air tube transport system 1 with the branching of the tubes 16, 17 achieved by the switch 15 extends, advantageously, in the z-direction. Other arrangements, in accordance with the present disclosure, are also possible depending on the spatial conditions.

In turn, at least one further branching switch 90 can be switched in each of the branching tubes 16, 17.

As shown in FIG. 3, an embodiment with a plurality of switches having the design of the switch 15 is also possible, according to the present disclosure.

According to an exemplary embodiment shown in FIG. 3, three drop-off branches 100a, 100b, 100c are provided, which in turn can each be configured in various ways and which each comprise at least one or more delivery stations 72.

According to FIG. 3, for example, the delivery branches 100a and 100b each have only one of the delivery stations 72. The delivery stations 72 can, in turn, each be differently configured.

Initially, each tube 16a, b of the two delivery stations 72a, b ends in a controllable separator 18a, b which can be adjusted with a pneumatic adjusting device in such a manner that,

in a first switching position, a connection of the tube 16 can be made with a vertically extending drop tube 19 or,
in a second switching position, a connection of the tube 16 can be made with a tube 20 arranged coaxially thereto.

In the examples shown, in accordance with the present disclosure, the tube 20 leads to an end separator 47, where, alternatively, further separators 18 or further switches can also be connected (not shown).

The separators 18 can either lead directly to a collecting container on the respective assembly device (not shown) or they can open via, respectively, single- or multi-stage branching switches into different collecting containers 50.

In the delivery branch 100a, the separator 18a opens in its one switching position, as shown, through the drop tube 19a into a 3-2-way drop tube distributor (see FIGS. 32, 33) located thereunder, which selectively distributes the parts flow by the controller 6 to the containers 50, which may be designated as 50-1 or 50-2.

The delivery branch 100b is described herein (see, for example, FIGS. 1, 3). In the delivery branch 100b, the separator 18b opens in a first switching position though the drop tube 19b into a 5-4 way rotary tube distributor 21 located thereunder, which comprises four bends 22, 23, 24, 25 each offset by 90 degrees on the fixed housing 211 (see, for example, FIGS. 3, 34, and 35). These are each formed with a downwardly directed free end. Located inside the distributor 21 is a rotatably mounted feed tube 26 which can be driven in a circulating manner by an electric drive 214 and which can be positioned in such a way that four switching positions can be achieved, in which, respectively, one of the bends 22 to 25 can be connected to the drop tube 19.

According to FIG. 1, four devices 27, 28, 29, 30 having storage containers 31, 32, 33, 34 each having tubular filler necks 35, 36, 37, 38 are located below the distributor 21. The devices 27 to 30 are configured as further processing machines, such as assembly machines, packaging machines or other treatment or processing machines. Located on each of the filler necks 35, 36, 37, 38 is at least one sensor 39, 40, 41, 42 for detecting the fill level. Alternatively, for example, at least two sensors can be provided for detecting a minimum and maximum fill level. The bends 22 to 25 can be connected to the filler necks 35 to 38 by flexible hoses 43, 44, 45, 46.

Advantageously, the part of the tube 14 extending upwards in the y-direction (see FIG. 1) runs with its horizontal section and the adjoining components in the upper part, for example, near the ceiling of the factory building. Whereas, the devices 27 to 30 are arranged on a floor b. It is advantageous if the distributor 21 is located a few meters, for example, 4 meters, above the adjacently disposed devices 27 to 30 so that sufficient kinetic energy is available for the supply line into the corresponding storage containers 31-34.

In accordance with a further embodiment of the present disclosure, for extension of the system it is feasible that the separators 18, in the manner of the delivery branch 100c, initially open into a tube to which an air flow generator X2 with a downstream butterfly valve X9 is assigned, which can be advantageous if the small assembly parts are to be conveyed over relatively large distances. The delivery branch 100c therefore comprises a separator 18c to which an inlet X8 and air flow generating device X2 with butterfly valve X9 are connected downstream as an air re-supplier or booster element, designated with an X.

The extension of the compressed-air tube transport system 1 in the x-direction, that is, the distance from the drop-off station 71 to the end separator 47 or to the end separator 47 located at the furthest distance, can, for example, be up to 100 meters.

By using booster arrangements, as shown in FIG. 3 (see delivery branch 100c), the distance, or range, can be arbitrarily varied. To this end, the delivery branch 100c is configured in a particular manner. That is, it is not used for the direct supply of small assembly parts to a delivery station 72 but to send the small assembly parts running therethrough on to a further section. The small assembly parts arriving in the separator 18c are fed directly into a stationary inlet X8 which functions, in principle, similarly to the inlets 8, 12 described elsewhere herein. Similarly, as described in the drop-off branches 1a, b, c, a fan, or air flow generator, X2 conveys the parts falling into the inlet X8 into a tube X14 to which a conveying system, such as that described, can be connected. With this concept, according to the present disclosure, the conveying range limitation of such an installation is eliminated so that even large distances can be covered.

In principle, large distances would need to be bridged by strong air conveying devices, but the flow losses occurring in the tubes would increase disproportionately and the expenditure for regulating the air flow would increase, further associated with additional start-up and shut-down times.

A mixed arrangement is also possible, in accordance with the present disclosure, in which a 3-2-way branch either branches into a delivery station 72 or into a booster arrangement, for example, of booster elements as described previously herein.

Depending on the design of the system according to the present disclosure, the booster arrangement can also be designed without butterfly valve X9 and/or without the possibility of passing the small assembly parts flow in the separator to an end separator. Extremely simple designs are then feasible, in accordance with the present disclosure, in which fan, separator and inlet can be arranged and/or designed as one assembly.

The alternative switching position of the separator 18a, b, c passes the air flow through the tube 20a, b, c to the end separator 47a, b, c. This switching position is usually not used for small assembly parts transport but for “blasting” the tubing. That is, after the actual small assembly parts transport has been completed, the air flow is usually maintained for a further period, although, in the drop-off branch, no further small assembly parts can be conveyed into the inlet in order to ensure transport of the last small assembly part to the destination site.

In order to ensure that after switching to a different transport path or to another type of part, no incorrect small assembly parts are still located in the tube, the tube can be acted upon by an air flow in a cycle preceding the actual new transport cycle, that is, before the commencement of the conveyance of small assembly parts into the inlet. There, however, the separator 18, or possibly all those connected successively, guides the air flow through the tube 20 to the respective end separator 47, which has a connection of the tube 20 to a downwardly pointing tube connector 48 and an upwardly directed outlet opening 49. Located under the tube connector 48 is a collecting container 50 suspended on the end separator 47 in which incorrectly passed small assembly parts can be collected (see for example, FIG. 38). These are conveyed by the air flow into the housing 471 of the separator 47 and impact against the baffle plate 473. The conveying air escapes upwards through the outlet opening 49 while the small assembly parts drop through the tube connector 48 into the container 50.

In FIG. 1, the devices 27, 28, 29 and 30 are located on a floor b of the factory building. In the case of a daily throughput of large quantities of conveyed goods having a weight of several tons, it is advantageous, according to the present disclosure, if the floors a and b extend substantially in the same plane. On the other hand, however, the floors a, b can be located on different planes as is the case, for example, when the compressed-air tube transport system 1 extends over different floors of a factory building.

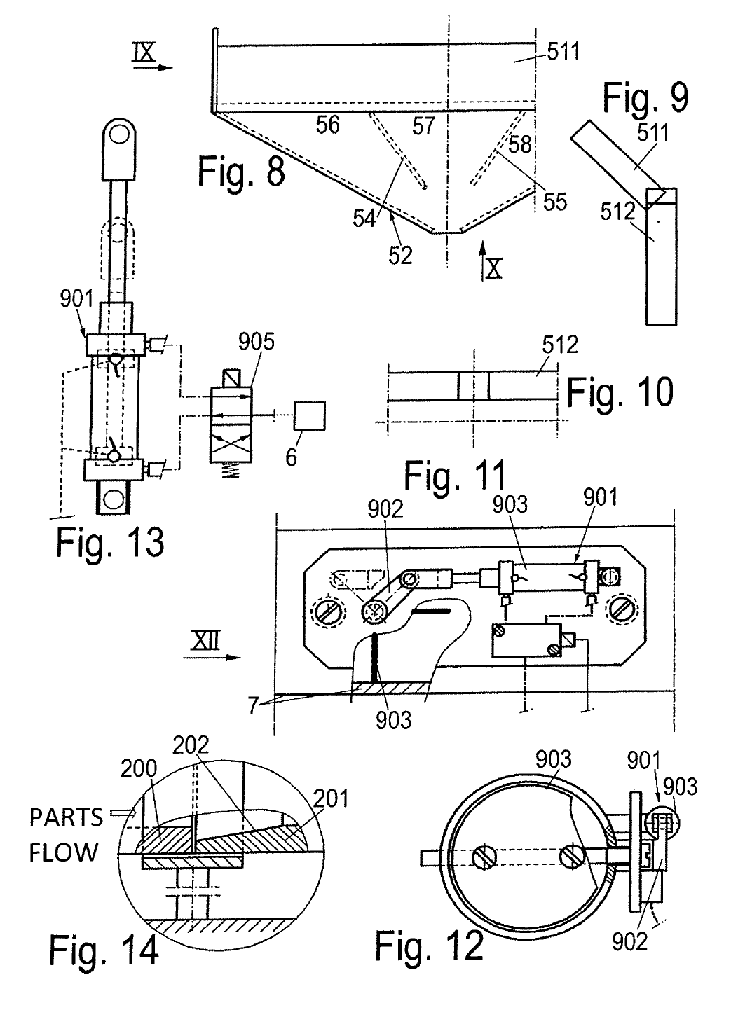

A framework 51 made of angle steel to which adjacently disposed and identically configured hoppers 52 and 53 are fastened, is supported on the floor a in the area of the drop-off station 71. These can, advantageously, be made of steel sheet and configured as hollow bodies in which two baffles 54 and 55 are located. Thus, three openings 56, 57, 58 are formed, for example, on the hopper 52 (see FIG. 8). Located above these openings are bunkers 59, 60, 61 fastened to the framework 51 which are also made of steel sheet and can be configured to be box-shaped with a lower funnel-shaped part. In the same design and arrangement, according to the present disclosure, bunkers 62, 63, 64, configured according to the bunker 59, are located above the hopper 53 and fastened on the frame 51.

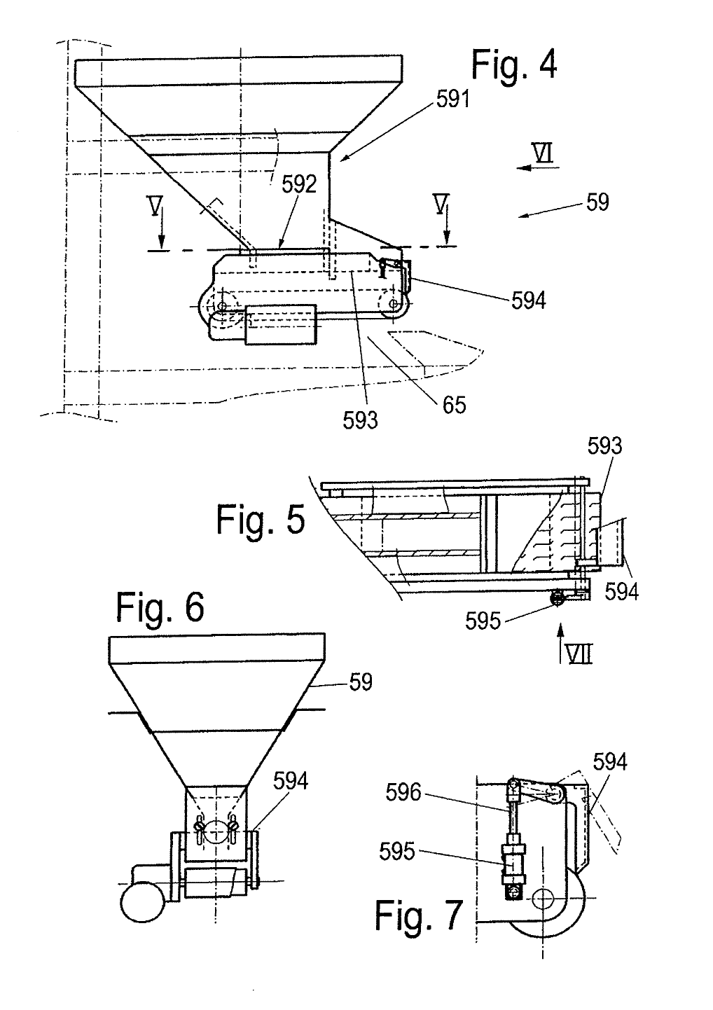

The bunkers 59 to 64 are identically configured and the following description is restricted to the bunker 59 (see FIG. 4). At the lower edge facing the opening of the inlet hoppers 52, there is a window below which the top of an electrically drivable conveyor belt 593 is located at a distance of, for example, two to five times the small assembly part size of the conveyed material, depending on dimensions and stack slope of the small assembly parts to be conveyed, which conveyor belt in cooperation with a flap 594 is designated as a metering conveyor 65.

Corresponding metering conveyors 65 are assigned to the bunkers 60, 61, 62, 63 and 64.

According to FIG. 1, the bunkers 59 to 64 are filled with different components t1 to t6, which can form a bulk material and, for example, are small assembly parts, for example, bolts, rivets, screws, tappets, pins or smaller housing parts made of metal, plastic, wood or other materials.

For the dimensions of the small assembly parts, it is specified that, according to an embodiment of the present disclosure, in their maximum size these can be spanned by an imaginary sphere having a diameter of about 3 to 5 centimeters and may have a weight of up to 20 grams.

The tubes and hoses may have an inside diameter that is about three to four times that of the imaginary sphere, that is, for example, about 10 to 20 centimeters.

Another embodiment of components of the compressed-air tube transport system, in accordance with the present disclosure, are described herein and with reference to at least FIG. 4.

FIGS. 4 to 6 show a detailed view of an embodiment, according to the present disclosure, of one of the bunkers 59 for receiving conveyed material in a side view corresponding to the z-y plane (see FIG. 4) and in the sectional view V-V of a part of the bunker 59 (see FIG. 5).

The bunkers 59 may have a lower funnel-shaped part 591. At the lower edge facing the hopper 52 (see FIG. 1), each bunker 59 has a window 592 below which, at a distance of several centimeters, about two to five times the small assembly part size of the conveyed material being selected as the distance, there is located the top of the already mentioned electrically drivable conveyor belt 593 to which a pneumatically pivotable flap 594 is assigned.

The conveyor belt 593 and the flap 594 each form the metering conveyor 65 of the bunkers 59 to 64.

If the flap 594 is opened and the conveyor belt 593 is driven, the small assembly parts fall over the free edge of the conveyor belt 593 downwards into the inlet hoppers 52, 53.

The flap 594 can be assigned a pneumatically actuatable adjusting cylinder 595 as an actuator, which can be controlled by the control device 6 and whose piston rod 596 can be coupled to one end of the rotatably mounted flap 594 in order to open (see the dashed diagram in FIG. 7) and close (see the non-dashed diagram of the flap 594 in FIG. 7) the flap 594. The function of the flap 594 is to reliably prevent any undesired conveyance of small assembly parts into the inlet hopper.

FIG. 8 shows a detailed front view of the inlet hopper 52, 53 in the x-y plane, where the hopper 52, 53 comprises a structure which is configured symmetrically to a vertical. FIGS. 9 and 10 show views of the hoppers 52, 53.

One or more of the bunkers 59 to 64 are located above the inlet hoppers 52 and 53.

The hoppers may have a sliding slope 511 located below the free end of the conveyor belt 593, which guides the small assembly parts into the actual hopper region 512. This hopper region can have the inner baffles 54, 55.

FIG. 11 further shows a section of the conveying tube 7 with the butterfly valve 9 which can be brought into a locking position and into an open position by a pneumatic drive 901 and an actuating lever 902 downstream thereof, the two positions being shown by the lever positions indicated by the solid and dot-dash lines with correspondingly bold lines as parts of the locking disk 903, and by which the tube 7 can be shut off or released.

FIG. 13 shows an enlarged view of the pneumatic drive 901 in the vertical position in the form of a double-acting pneumatic cylinder 903 with sensors for feedback of the switching state with retracted or extended piston rod 904 including an electrically actuatable 4-2-way valve 905 shown symbolically. All the pneumatic cylinders used in the assemblies described correspond to this design, in accordance with the present disclosure. Alternatively, in accordance with the present disclosure, other, for example, electrical actuators can also be used.

An advantage of the shut-off unit 9 downstream of the respective air flow generators 2 of each drop-off branch, which shut-off unit may be configured as a constructively simple and robust butterfly valve 9, is that by actuating the flaps it is possible to rapidly and simply release or close the air flow conveying the small assembly parts in the respective drop-off branch. Also for the “blasting” of tubings by rapid actuation, as described above, a pressure surge can be induced through the line which can release any fixed or hooked-up small assembly parts.

If the flap is closed, which may be advantageous when the drop-off branch concerned is not specifically being used, the power consumption of the upstream air flow generator decreases immediately without its rotational speed needing to be reduced, which would cost some time depending on the device. Conversely, the air flow generator need not be started up in a time-consuming manner after a pause, whereby the availability of the system is increased.

Since each of the drop-off branches, for example, 1a, 1b, 1c, has its own shut-off device, the compressed-air tube transport system can be switched simply and rapidly to each one of the drop-off branches 1a, 1b, 1c. It is within the scope of the present disclosure, in a simple manner, to limit the conveying air flow precisely to a predefined time interval after the last small assembly part to be conveyed falls out from one of the bunkers 59 to 64. The switching over of the numerous switches of the system is also advantageously accomplished with the air flow switched off.

FIG. 14 shows another embodiment of a portion of a small parts conveying system, according to the present disclosure.

In this embodiment, in the region of a butt joint of two tubes that is, a first tube 200 and an abutting tube 201 which extends the first tube part, a bevel 202 is formed at the inlet of the tube connected at a further distance in the conveying direction, that is, in the +x direction, which bevel 202 optimizes the flow in the region of the tube butt joint and prevents sticking or damage to the conveyed small assembly parts even when the tubes are not precisely in axial alignment.

This can be achieved at any tube butt joint of the compressed-air tube transport system, according to the present disclosure. That is, both in fixedly mounted tubings and also in the functional components described, for example, at switches.

At tube transitions, for example, at the movable transitions within the switch assemblies, no special sealing components are used. On the contrary, as a result of the bevelling, according to the present disclosure, of the more distant tube in the conveying direction, an air flow similar to the Venturi effect is achieved which keeps leakages flows small so that seals are superfluous.

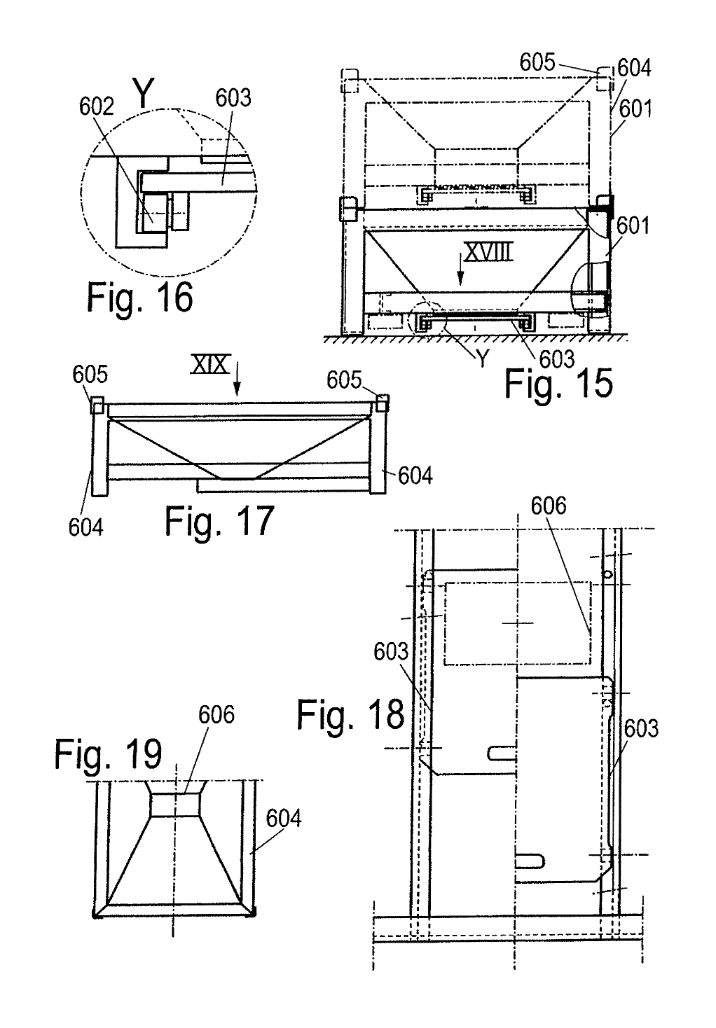

FIG. 15 shows a front view, in the x-y plane, of two bunker extensions placed one upon the other in the form of a mobile storage container 601, which jointly have a size which corresponds to the size of a usual transport container for transporting the small assembly parts.

To this end, the funnel-like part 591 of the bunker (see, for example, FIG. 4) may be configured in such a manner that it is possible to arrange the small assembly parts transport and storage container 601 directly above the funnel-like part 591, which, as transported, needs to be placed on the funnel-like part 591 and opened on the underside. That is so that the funnel-like part 591, or therefore the respective bunker 59 to 64, is filled with the small assembly parts.

It is within the scope of the present disclosure to sense the filling state of the individual bunkers with small assembly parts in the bunker 59 or, however, to calculate the consumption of small assembly parts from the bunker 59 computationally in order to indicate to the user when it is necessary to place a new storage container 601 with small assembly parts on the respective bunker 59.

FIG. 16 shows an enlarged view of detail Y from FIG. 15. The roller bearing 602 of a slider 603 is shown, by which the bunker extension, that is, the respective transport and storage container 601, can be opened and closed on its underside.

The bunkers 59 to 64 and/or the transport and storage container 601 have a frame construction 604 with centering pieces or angles 605 in order to hold and to center or align the transport and storage container 601 on the bunkers 59 to 64.

FIG. 15 illustrates that a plurality of transport and storage containers 60 can be stacked one above the other, in accordance with the present disclosure.

FIG. 17 shows, schematically, a corresponding side view of one of the bunker extensions in the manner of the transport and storage container 601 corresponding to the x-y plane in reduced scale. FIG. 18 shows a plan view on an enlarged scale of a lower region of the bunker extension 601, in accordance with the view of the arrow XVIII in FIG. 15. That is where halves of the slider 603 are shown in a position closing the rectangular outlet opening 606 of the storage container, indicated by the dot-dash line, on the left side, and a position which releases the outlet opening of the storage container, on the right side. FIG. 19 shows a plan view of the bunker extension in a partial view turned through 90 degrees, according to the direction of the arrow XIX in FIG. 16.

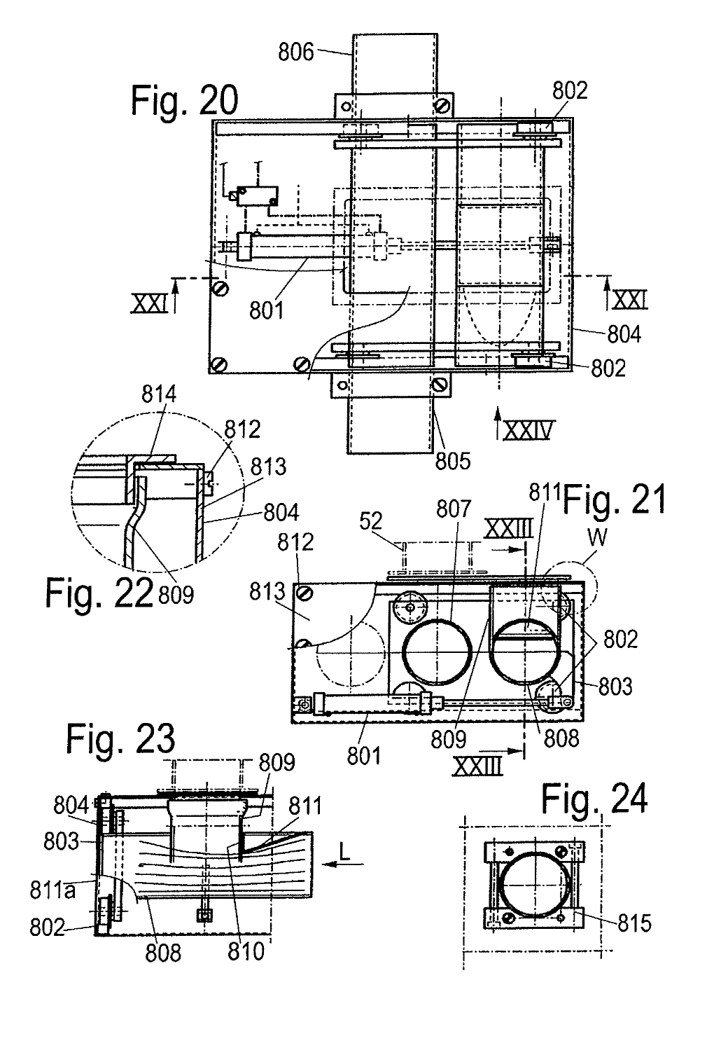

FIG. 20 shows a plan view of the inlet devices 8 in the x-z plane on an enlarged scale.

Each of the inlet devices 8 has a tube carriage 803 which can be moved by a pneumatic cylinder 801, which may have the design shown in FIG. 2, and which may be provided with rollers or wheels 802.

This tube carriage 803 may be moved or displaced into two end positions inside a surrounding, protective housing 804.

The tube carriage comprises two tube pieces 807, 808 which are arranged parallel to one another and aligned horizontally.

These tube pieces 807, 808 serve to interconnect two tube connectors 805, 806 arranged on the front side in one or other end position of the tube carriage 803. According to FIG. 1, a continuous horizontal tube connection is formed in such a manner below the inlet devices 8, 12, that is, between the tubes 7 and 10.

One of the two tube pieces is configured as a circumferentially closed continuous tube piece 807. It connects the tube connectors to one another in one end position of the tube carriage, wherein the inlet opening of the inlet device is closed in the direction of the inlet hopper, for example, inlet hopper 52.

The other of the two tube pieces is configured as an inlet tube piece 808 having an upper vertical shoulder or inlet 809 which is disposed below the outlet of the corresponding inlet hopper 52.

In such a manner, in the other end position of the tube carriage 803, the connection to the inlet hopper 52 is opened so that small assembly parts can drop from the inlet hopper 52 into the tube system which is acted upon by a compressed air flow from the air flow generator 2.

In order to optimize the flow relationships in the area of the inlet, it is advantageous if the vertical tube shoulder 809 extends by a small amount into the appurtenant horizontal tube piece 808 so that a constriction which accelerates the air flow is formed. It is further advantageous if the inner circumference of the tube piece 808 is connected in the flow direction L to the end region 810 of the tube shoulder 809 which projects into the tube piece. That may be by way of the air baffle 811 aligned at an acute angle to the horizontal, having the inside diameter of the tube piece 808 in order to avoid turbulence in this region and to guide the flow so favorably that despite open inlet opening and flowing air, small and light assembly parts fall into the tube 808 and are not blown out again.

By way of this air baffle 811 forming an air guiding slope in the region of the constriction in the area of the mouth of the vertical tube shoulder 809, the flow relationships in the area of the small assembly parts transfer from the bunker or inlet hopper into the compressed-air tube system are significantly improved compared with the prior art. In particular, a continuous inflow and removal of parts is possible, in accordance with the present disclosure, with the result that larger quantities of small assembly parts can be conveyed in one passage to a destination site. The vertical tube shoulder 809 can be bent by an angle of 10° to 60°, for example, between 30° and 50°, in the flow direction so that incoming individual small assembly parts enter into the tube piece 808 accelerated in the flow direction. As a result, air is still sucked into the tube so that any blowing out of parts is reliably avoided.

FIG. 21 shows a view of the inlet system according to the sectional profile XXI-XXI in FIG. 20 with a part of a side plate 813 of the housing 804 fastened with screws 812. The box-like structure of the housing 804 is composed of sheets. This structure has proved advantageous, according to the present disclosure, in order to be able to manually rectify, for example, small assembly parts blockages in a short time.

FIG. 22 shows an enlarged sectional view of detail W from FIG. 21. This detail relates to a flange piece 814 on the vertical tube shoulder 809 or an addition to the vertical tube shoulder which allows the upper inlet hopper 52 to be flanged in a simple manner (not shown).

FIG. 23 shows a sectional view of the inlet device 8 according to the sectional profile XXIII-XXIII in FIG. 21. The air baffle 811 can be seen here and wherein the conveying air flow is constricted and accelerated thereby, is indicated by the relatively thinner solid lines.

FIG. 24 shows a view of a part of the inlet device 8 according to the direction of the arrow XXIV in FIG. 20. The fastening of the tube connector 805 or 806 with a flange clamping device 815 spanning said connector is shown.

The tube pieces 807, 808 and the tube connectors 805 and 806, as in the example explained in FIG. 14, have a bevelling of the tube inlets with the result that expensive sealing measures, for example, of the movable tube sections, can be omitted and the sticking of individual parts is avoided. This measure is also applied to all other movable and immovable tube transitions as may be disclosed herein without this measure being mentioned again at the concerned points in the present disclosure.

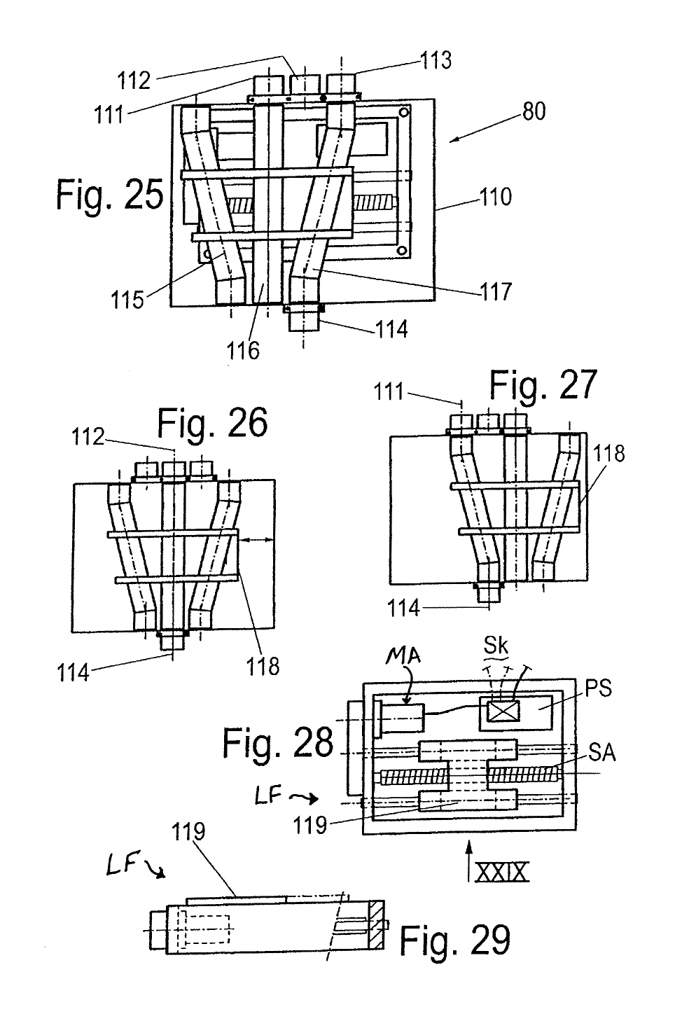

FIG. 25 shows a plan view, according to the x-z direction, of a switchable 4-3-way switch 110 which can be used, for example, as a joining switch 80 or as a branching switch 15. However, the bevellings discussed previously must be placed on the tube inlets located in the flow direction.

The switch 110 is used for selectively making a connection, for example, from one of the three, for example, incoming tube connectors 111, 112, 113 to one, for example, outgoing tube connector 114. The connecting tubes 115, 116, 117 are arranged jointly as a connecting tube unit 118 on a sled, or carriage, 118 and wherein a first switching position is shown. FIG. 26 shows the connecting tube unit 118 relative to the housing in a second switching position and FIG. 27 shows the connecting tube unit 118 relative to the housing in a third switching position.

FIG. 28 shows a guide and drive unit 119 carrying the connecting tube unit 118 and FIG. 29 shows a view of the guide and drive unit in the direction of the arrow XXIX in FIG. 28. In addition to a linear guide unit LF, for example a double sliding tube guide is shown, a spindle drive comprises a linear drive unit, and the spindle drive is shown. This may be driven by an electric motor MA which in turn is controlled by a position control unit PS. This can be connected to the central control of the tube transport system via control cable SK. The detection and feedback of the switch position can, as in the previously described rotary tube switch, be accomplished with simple switch sensors associated with the respective position, which can be placed in the region of the linear guide elements or directly in the region of the respective displaced tube connector.

Alternatively, actuation of the switch with pneumatic cylinders is within the scope of the present disclosure. That is where a plurality of cylinders are used advantageously, which each individually or actuated in a specific combination, generate a specific switch position so that position detection of the switch by sensors can be omitted. The feedback of the pneumatic cylinders is sufficient.

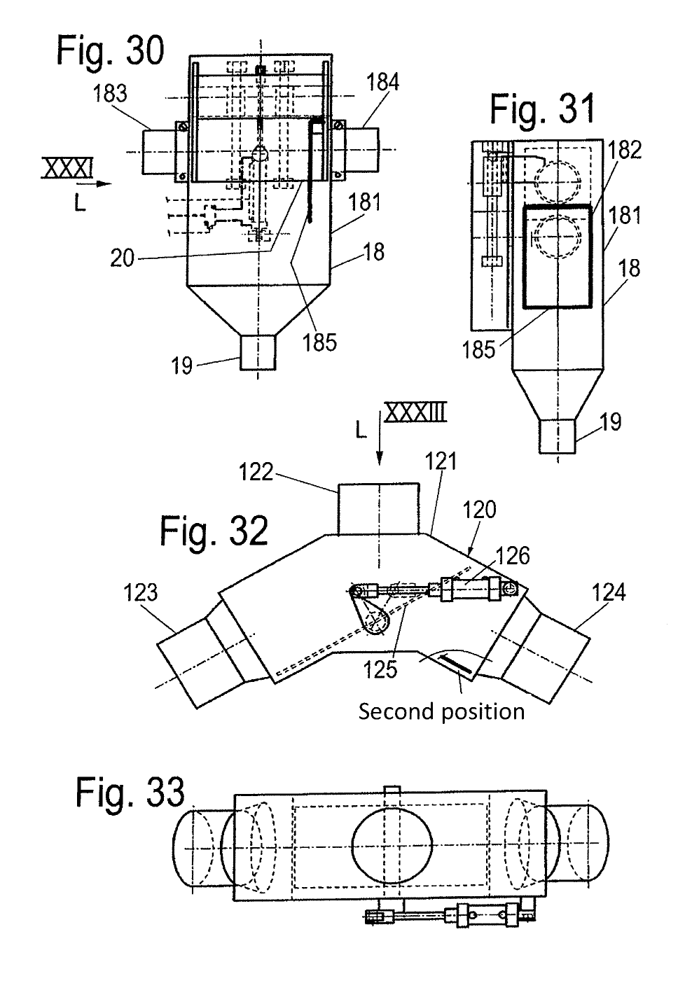

Separators 18 may be arranged in the area of the delivery stations, as shown in FIGS. 30 and 31. The separator 18 has a housing 181 and may have a pneumatically actuated adjusting device 182. This adjusting device 182 is provided with a horizontally extending tube piece 20 which is movable into a position connecting the two tube connectors 183 and 184 and into a position not connecting these tube connectors 183 and 184. A shut-off element 185 is provided in the adjusting device which shuts off the tube connector 184 running out in the flow direction L for the exit of single small assembly parts when the tube piece 20 does not interconnect these two tube connectors 183, 184.

In such a manner, a connection of the tube 16 to the tube 20 arranged coaxially thereto can be made in one switch position and a connection of the tube 16 to the drop tube 19 extending perpendicularly can be made in another switch position.

In one position, the small assembly parts are passed through the separator 18 into successively located system sections and in the other switch position the small assembly parts in the separator 18 are passed into the drop tube 19.

The shut-off element 185 can be mounted at different locations in the flow direction, at different slopes and height optimised for the individual case and, depending on the condition and material of the small assembly parts to be separated, can be designed as a rigid part, for example, a sheet part, an elastic part, for example, made of silicone rubber, and also, for example, as textile cloths. The crucial thing is that the small assembly parts flying through the air flow are retarded without damage so that they drop downwards into the drop tube 19 while the air transporting as far as here can escape upwards through a sound suppressor or around the shut-off element out from the tube piece 184 into the surrounding space.

In this separation process, the property of the tube transport system is very advantageous in that the velocity of the conveyed parts decreases towards the separator. The velocity is highest in the vicinity of the driving air flow generator, for example, at the inlet and lowest towards the end of the path, for example, at the separator.

FIG. 30 shows a view into the interior of the separator 18 corresponding to the x-y plane with a guide and drive unit indicated by the dashed line and FIG. 31 shows a view of the separator 18 according to the direction of the arrow XXXI in FIG. 30. As described previously in other assemblies, both an electric or a pneumatic drive can be used here, sensors again being provided to detect the respective position.

FIG. 32 shows a view of a 3-2-way drop tube distributor 120 having a housing 121 with an inlet tube connector 122 and two outlet tube connectors 123, 124. This is used to sub-distribute and further distribute the small assembly parts falling out from the separator to two different receiver branches.

Located in the housing 121 is a pivotable baffle flap 125 to either connect the one outlet tube connector 123 or the other outlet tube connector 124 to the inlet tube connector 122 which in turn may be connected to the drop tube 19 of the separator 18. The connection between the inlet tube connector 122 and the drop tube 19 can be made by a flexible hose or also directly. The transport of the small assembly parts in this section of the system is accomplished merely by gravity.

The baffle plate 125 may be actuated with a pneumatic cylinder 126, wherein one switching position of the baffle located in the interior and another switching position through a part of the baffle on a cutaway housing part, as can be seen in FIG. 32. FIG. 33 shows a plan view of the 3-2-way distributor in the direction of the arrow XXXIII in FIG. 32.

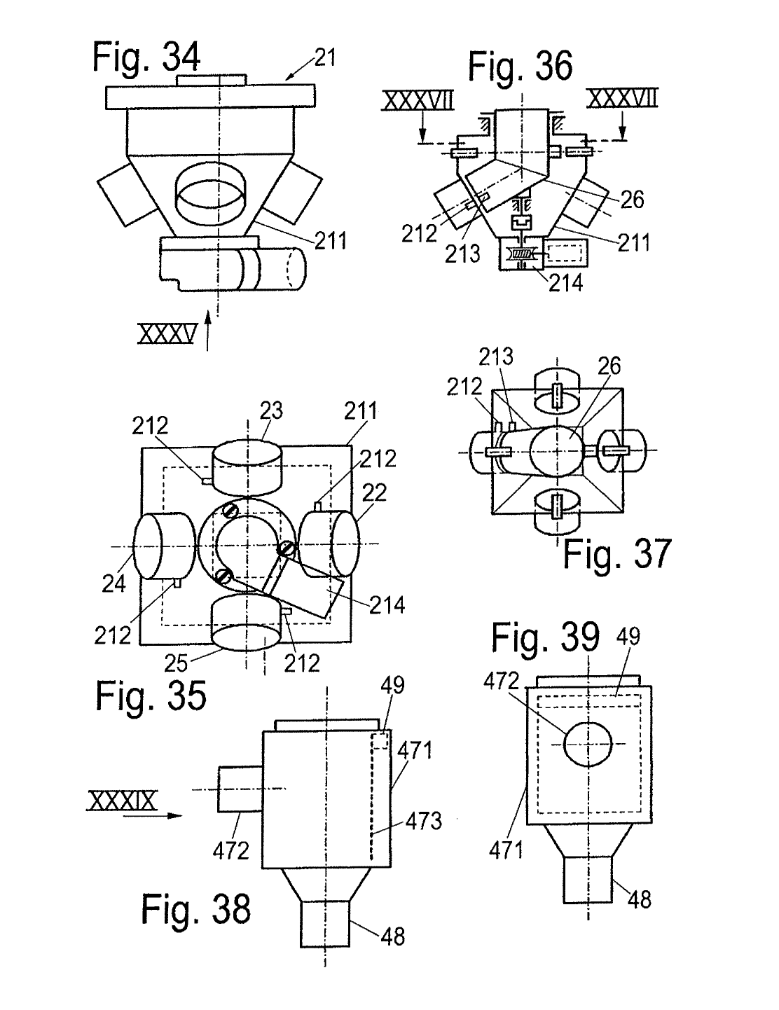

FIGS. 34 to 37 show various views of one of the drop tube rotary switches 21 or the rotary distributor 21 which comprise bends or tube connectors 22, 23, 24, 25 each offset by 90 degrees on a fixed housing 211. This embodiment, according to the present disclosure, may have fewer bends, such as three, or may have more, such as five or eight, bends or tube connector outlets.

Located inside the distributor 21 is a rotatably mounted feed tube 26 which can be driven circumferentially by a controllable electric drive 214 and which can be positioned in such a manner that four switching positions are attainable, in which, respectively, one of the bends 22 to 25 can be connected to the drop tube 19. The correct switching positions in which the drop tube 26 is in alignment with, respectively, one of the bends 22 to 25, may be sensed by sensor/detector devices 212, 213 which allows a particularly exact alignment of the bends in a simple manner.

An advantage of this position detection for the rotary tube is that it manages without complex rotary angle sensors. To this end, suitable sensors 212, 213, advantageously contact switches, such as proximity switches or similar switches, and robust sensors which switch between two states, are located at each desired position so that the attainment of a position, which can be predefined by the controller, can be detected by a clear signal of the corresponding sensor. The sensors can, for example, be positioned on the tube connectors 22 to 25 and the corresponding end of the drop tube 26, such as sensors 212, 213, or also on the upper section of the tube 26 mounted rotationally in the housing 211 and on the housing 211 (see sensors 212′, 213′ in FIG. 36).

FIGS. 38 and 39 show views of the end separator 47 with a housing 471 and with a tube connector 472 on which the tube 20 can be flanged or into which the tube 20 opens and which has a connection of the tube 20 to the downwardly pointing tube connector 48 and the upwardly directed outlet opening 49 for air. In turn, a collecting container 50 suspended on the end separator 47 can, but need not, be located below the tube connector.

Taking into account the previous description above regarding the present disclosure, FIG. 3 is considered again.

FIG. 3 shows an operating state in which small assembly parts can be guided from the single bunker 59 of the middle drop-off branch 1b, in the left-hand region of FIG. 3, through the tube system to the lower delivery station in the right-hand part of FIG. 3.

For this purpose, the butterfly valve 9b of the middle drop-off branch is, for example, switched in the passage position and the inlet device 8b is configured in such a manner that small assembly parts falling out from the bunker 59, by activation of the metering conveyor 65 into the inlet hopper 52, fall into the tube 7b, 14b and are guided through the joining switch 80 and the downstream branching switch 15 into the lower separator 18a in FIG. 3. The lower separator 18a passes them, for example, through the 3-2-way distributor 120 into the collecting container 50-1 which is disposed at an assembly station, for example, on a screw conveyor or the like.

At a predefined time, only the transport of one type of small assembly parts from one of the bunkers to one of the delivery stations 71 in the system is allowed.

A favorable control method ensures, that by matching operating parameters, such as the air flow and duration, to the condition of the small assembly parts to be conveyed and to the distance from inlet to separator that on the one hand, the small assembly parts arrive safely, but on the other hand, the control method does not impinge unnecessarily rapidly on the shut-off element in the separator.

For this purpose, the control method parameterizes suitable air flows and conveying times for each conveying task, evidenced by drop-off branch and bunker, type of small assembly part considering, for example, weight and dimension, and considering distance to be covered up to the conveying destination, and number and condition of switches.

It is advantageous, according to the present disclosure, after each small assembly parts conveying cycle, to initially switch the system flow-free by the butterfly valve 9 without shutting down the air conveying systems before the switch circuits are made for the next conveying path.

This is then followed by a “blasting cycle” in order to ensure that no more undesired small assembly parts are located in the tube system. To this end, all the separators in the respective destination drop-off branch are switched through to the final end separator and the inlet unit of the drop-off branch is initially switched to “passage”, for example, the inlet opening remains closed. By opening the butterfly valve 9, air now flows through the entire conveying path and as far as the end separator of the delivery branch, whereby small assembly parts which may be stuck are released by the pressure surge and eliminated together with any further residual small assembly parts located in the tube in the end separator.

Only after this, after closing the butterfly valve 9, the inlet 8 and the separator 18 are switched into the transport path. After opening the butterfly valve 9, the flap 594 of the metering conveyor 65 is opened and this is set in operation. By this, the small assembly parts are conveyed continuously into the inlet.

If the fill level sensors of the storage containers or filler necks on the destination side notify the controller that a sufficient fill level is reached, the metering conveyor is initially stopped and the flap 594 closed while the air flow runs through for a time appropriate to the conveying task. Only when it is thereby ensured that the last metered small assembly part has arrived at its destination, is the butterfly valve 9 closed and the next transport cycle begins.

If, for example, as a result of the small assembly parts requirements present at the controller, a drop-off branch is prospectively no longer required, the air conveying device pertaining to this branch can be shut down to save further energy. Similarly, the air conveying device can be started up again by the controller in good time if small assembly parts requirements for the relevant drop-off branch are present, wherein this start-up can already take place during the preceding transport cycle in order to be ready for the following cycle. The closed flap or valve 9 prevents the starting-up air conveying device from have a disturbing influence on the ongoing small assembly parts transport.

It has furthermore proved to be favorable, in accordance with the present disclosure, that a plurality of conveying tasks can be combined for the drop-off branch in order to optimally utilize the air conveying device which has been started up. To this end, the controller assigns priorities to the material requirements and sorts the transport tasks according to drop-off branches. This in turn means that the material requirements transmitted to the controller from the sensors on the storage containers on the production equipment are accomplished in good time before the respective stores run completely dry and do not result directly in a small assembly parts transport. On the contrary, the remaining residual running time of a device with the remaining small assembly parts is a parameter stored in the controller which allows combining of the transport tasks described above to be carried out for, respectively, the same drop-off branches.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A pneumatic compressed-air tube transport system for transporting small assembly parts to assembly and processing lines for assembly of products, the transport system comprising:
at least one drop-off branch configured to drop-off the small assembly parts into the compressed-air tube transport system, the at least one drop-off branch including
at least one air flow generator,
a butterfly valve located downstream of the air flow generator, and
a drop-off station for the small assembly parts located downstream of the butterfly valve,
which small assembly parts move through a tube into at least one joining switch; and
a plurality of delivery stations configured to receive the small assembly parts.

2. A pneumatic compressed-air tube transport system for transporting small assembly parts to assembly and processing lines for assembly of products, the transport system comprising:
three drop-off branches configured to drop off the small assembly parts into the compressed-air tube transport system, each drop-off branch including
an air flow generator,
a drop-off station for the small assembly parts, and
which small delivery parts move through a tube into at least one joining switch; and
a plurality of delivery stations for configured to receive the small assembly parts.

3. The pneumatic compressed-air tube transport system according to claim 1, further comprising at least one branching switch located upstream of the delivery stations.

4. The pneumatic compressed-air tube transport system according to claim 1, wherein the drop-off station includes at least one bunker for the small assembly parts and at least one inlet device.

5. The pneumatic compressed-air tube transport system according to claim 4, further comprising an inlet hopper which opens into the at least one inlet device located below the at least one bunker.

6. The pneumatic compressed-air tube transport system according to claim 4, wherein the tube is connected to the at least one air flow generator of the at least one drop-off branch, into which the at least one drop-off branch of the at least one inlet device is switched, further wherein the tube located between the at least one air flow generator and the at least one inlet device is provided with the butterfly valve that is controllable.

7. The pneumatic compressed-air tube transport system according to claim 1, wherein the at least one inlet device is configured in such a manner that in a first switching position either a connection of an incoming tube with an adjoining outgoing tube is made or a connection to an inlet tube extending at an upward angle is made, and that in a second position a connection of the incoming tube to the adjoining outgoing tube is made and the connection to the inlet tube is shut off.

8. The pneumatic compressed-air tube transport system according to claim 4, wherein an inlet tube of the inlet device incoming in a flow direction of the air has a cross-sectional narrowing before a mouth of the inlet tube.

9. The pneumatic compressed-air tube transport system according to claim 8, wherein the cross-sectional narrowing is formed by an air baffle aligned at an acute angle to the inlet tube direction.

10. The pneumatic compressed-air tube transport system according to claim 4, wherein the at least one inlet device includes a tube carriage which is movable by a pneumatic cylinder, and which is movable into two end positions inside a surrounding housing.

11. The pneumatic compressed-air tube transport system according to claim 10, wherein the tube carriage includes two horizontally aligned tube pieces which are arranged parallel to one another and which serve to interconnect two tube connectors arranged on a front side in one or another end position.

12. The pneumatic compressed-air tube transport system according to claim 11, wherein one of the two tube pieces is configured as a circumferentially closed continuous tube piece which interconnects the tube connectors in one end position of the tube carriage.

13. The pneumatic compressed-air tube transport system according to claim 12, wherein the other of the two tube pieces includes an upper vertical shoulder which is arranged in the other end position of the tube carriage below an outlet of a corresponding inlet hopper.

14. The pneumatic compressed-air tube transport system according to claim 13, wherein the vertical tube shoulder extends into an appurtenant horizontal tube piece so that a cross-sectional narrowing which accelerates the air flow is formed.

15. The pneumatic compressed-air tube transport system according to claim 13, wherein an inner circumference of the tube piece is connected in a flow direction L to an end region of the tube shoulder which projects into the tube piece via an air baffle aligned at an acute angle to the horizontal.

16. The pneumatic compressed-air tube transport system according to claim 4, wherein the at least one bunker includes a metering conveyor.

17. The pneumatic compressed-air tube transport system according to claim 4, wherein the at least one bunker includes a funnel-shaped part below which an upper side of a conveyor belt is located and which is assigned to a pneumatically pivotable flap.

18. The pneumatic compressed-air tube transport system according to claim 17, wherein the conveyor belt and the flap each form a metering conveyor of the at least one bunker.

19. The pneumatic compressed-air tube transport system according to claim 4, wherein the at least one bunker is arranged above an inlet tube of an inlet hopper and above the inlet hopper.

20. The pneumatic compressed-air tube transport system according to claim 1, wherein a bevel is formed in an area of a butt joint of two tubes connected in a flow direction of air or in a transport direction.

21. The pneumatic compressed-air tube transport system according to claim 4, wherein the at least one bunker is configured in such a manner that bunker extensions in the form of mobile storage and transport containers for the small assembly parts can be placed directly thereon.

22. The pneumatic compressed-air tube transport system according to claim 21, wherein the at least one bunker and the transport and storage containers include corresponding frame constructions with centering angles in order to hold and to center the transport and storage containers on the at least one bunker.

23. The pneumatic compressed-air tube transport system according to claim 1, further comprising a separator including a housing and a pneumatically actuated adjusting device which is provided with a horizontally extending tube piece, which is movable into a position connecting two tube connectors and into a position not connecting the two tube connectors, so that in one switching position a connection of an incoming tube with an outgoing tube arranged coaxially thereto is made and in another switching position a connection of the incoming tube is made to a drop-tube.

24. The pneumatic compressed-air tube transport system according to claim 23, wherein a drop-tube rotary distributor is located downstream of the separator.

25. The pneumatic compressed-air tube transport system according to claim 24, wherein the drop-tube rotary distributor includes circumferentially offset bends on a fixed housing and a rotatably mounted feed tube is located inside the housing which is driven circumferentially by a controllable drive and positioned in such a manner that switching positions can be reached in which one of the bends is in alignment with the drop tube.

26. The pneumatic compressed-air tube transport system according to claim 25, wherein the switching positions, in which the drop tube is in alignment with one of the bends, are sensed and controlled by a sensor device.

27. The pneumatic compressed-air tube transport system according to claim 26, wherein a sensor is provided per each switching position and operates like a switch and delivers a signal on reaching a target position.

28. The pneumatic compressed-air tube transport system according to any claim 1, further comprising a control device which is provided with a control program for controlling the compressed-air tube transport system.

29. The pneumatic compressed-air tube transport system according to claim 1, further comprising at least one booster device for resupplying the air flow.

30. The pneumatic compressed-air tube transport system according to claim 29, wherein the at least one booster device for resupplying the air flow is located downstream of a separator.

31. The pneumatic compressed-air tube transport system according to claim 30, wherein at least one intermediate storage device is located below one or both of the separator and a rotary switch.

32. The pneumatic compressed-air tube transport system according to claim 1, further comprising an end separator in each of the plurality of delivery stations.

33. The pneumatic compressed-air tube transport system according to claim 32, wherein each end separator includes an air outlet and a faulty part collector.

34. A method for controlling the pneumatic compressed-air tube transport system according to claim 4, comprising the step of connecting at all times only one of the at least one bunker of the at least one drop-off branch to a separator or an end separator so that at all times only one type of the small assembly parts is located in a tube area of the compressed-air tube transport system which can be acted upon with compressed air.

35. The method according to claim 34, wherein a time of action of the air flow of the compressed-air tube transport system for transporting a specific type of small assembly part is determined in such a manner that no more small assembly parts are located in the tube area of the compressed-air tube transport system which can be acted upon with compressed air before another connection is activated between another of the at least one bunker and another of the plurality of delivery stations.

36. The method according to claim 35, wherein the time of action of the air flow of the compressed-air tube transport system for transporting the specific type of small assembly parts is longer by a pre-definable minimum time than the transport time to the separator calculated from a distance measurement and a small assembly part velocity in the air flow.

37. The method according to claim 36, wherein before a transporting of a new type of small assembly parts, an emptying air blast is introduced into the compressed-air tube transport system.

38. The method according to claim 34, wherein the time of action of the air flow of the compressed-air tube transport system for transporting a specific type of small assembly parts is longer by a pre-definable minimum time than the transport time to the separator calculated from a distance measurement and the small assembly parts velocity in the air flow.

39. The method according to claim 34, wherein an intensity of an air flow of the air flow generator is controlled according to one or both of a weight and shape of the small assembly parts to be transported.

40. The method according to claim 39, wherein the control parameterizes suitable conveying air flows and conveying times for each conveying task, determined by the at least one drop-off branch, the at least one bunker, the type of small assembly parts, a distance to be covered to a transport destination, and a number and condition of switches.

41. The method according to claim 34, wherein after a small assembly parts conveying cycle, the pneumatic compressed-air tube transport system is initially switched flow-free by the butterfly valve without shutting down the air transport system before switch circuits for the next conveying path have been operated.

42. The method according to claim 34, further comprising a blasting cycle that ensures that no undesired small assembly parts are located in tubes of the transport system for which the separators are switched through to a final end separator in a destination delivery branch and the inlet device of the at least one drop-off branch is initially switched to a passage mode whereupon by opening the butterfly valve air flows through an entire conveying path and as far as an end separator of the destination delivery branch wherein any stuck small assembly parts are released by a pressure surge and discharged in the end separator.

43. The method according to claim 42, wherein after closing the butterfly valve, the inlet device and the separators are switched and that after opening the butterfly valve a flap of a metering conveyor is opened and this is set in operation, whereby the small assembly parts are conveyed continuously into the inlet device.
